(19) United States
(12) Patent Application Publication
(10) Pub. No.: US 2022/0252483 A1
(43) Pub. Date: Aug. 11, 2022

(54) SENSOR AND MANUFACTURING METHOD

(71) Applicant: Continental Automotive GmbH, Hannover (DE)

(72) Inventors: Hervé Contet, Toulouse (FR); Martin Throm, Toulouse (FR)

(21) Appl. No.: 17/615,704

(22) PCT Filed: Jun. 18, 2020
(86) PCT No.: PCT/EP2020/067032

§ 371 Date: Dec. 1, 2021

(30) Foreign Application Priority Data
Jun. 25, 2019 (FR) FR1906868

(51) Int. Cl. G01M 15/05; G01B 7/30; G01D 5/14; G01P 3/481; B29C 45/14

(52) U.S. Cl. CPC G01M 15/05; G01B 7/30; G01D 5/145; B29K 2101/12; B29C 45/14655; B29C 45/1418; G01P 3/481

(57) ABSTRACT

A method for manufacturing a sensor for an automotive vehicle, the sensor includes an integrated circuit and a magnetic element. The method includes the steps of arranging the integrated circuit in a housing of a support zone of a leadframe formed in a metal base plate; the leadframe including branches constituting electrical tracks, electrically connecting the integrated circuit to the branches, placing the magnetic element against the support zone in line with the integrated circuit and at a predetermined fixed distance from the integrated circuit so as to form a space between the magnetic element and the integrated circuit, overmolding the assembly formed by the support zone, the integrated circuit and the magnetic element with a polyepoxide material so as to obtain an internal overmolding, overmolding the internal overmolding with a thermoplastic material so as to obtain the sensor.

### CROSS REFERENCE TO RELATED APPLICATIONS

This application is the U.S. National Phase Application of PCT International Application No. PCT/EP2020/067032, filed Jun. 18, 2020, which claims priority to French Patent Application No. 1906868, filed Jun. 25, 2019, the contents of such applications being incorporated by reference herein.

### FIELD OF THE INVENTION

The present invention relates to the manufacture of sensors for automotive vehicles and is notably aimed at providing an optimized method for the manufacture of an automotive-vehicle sensor.

### BACKGROUND OF THE INVENTION

In certain types of sensor employed in automotive vehicles, such as camshaft or crankshaft position or speed sensors for example, the sensor comprises a measurement cell comprising an integrated circuit and a magnet, positioned in line with said integrated circuit. Such superposition allows the integrated circuit to measure the variations in the electromagnetic field that are perceived by the magnet. In one known solution, the integrated circuit takes the form of a flat plate of rectangular shape overmolded with a polyepoxide material, while the magnet takes the form of a hollow cylinder of circular cross section.

Such a sensor is manufactured in the known way by performing several successive overmolding operations, notably an overmolding of the integrated circuit, this generally being performed by the manufacturer of the integrated circuit, an overmolding of the assembly formed by the overmolded integrated circuit and the magnet, referred to as “internal overmolding”, and an overmolding of the assembly formed by the internal overmolding and leads or a connection grating (known in the art as a “leadframe”), this latter overmolding being referred to as “external overmolding”.

Each overmolding operation generates tolerances with respect to the expected dimensions. In particular, because of these successive molding operations, the sensor exhibits flash and parting lines. Such lines lead to a loss of precision and of repeatability in the positioning of the measurement cell with respect to the “reading” face of the sensor, which corresponds to the face in line with the element that causes the variation in the magnetic field that is to be measured, for example a target mounted on a shaft of the vehicle. In general, the deviation caused by a parting line adds 0.05 mm of imprecision to the gap separating the measurement cell from the reading face, and the flash along the parting line may also add 0.05 mm. The thickness of the external overmolding also adds a tolerance of +/−0.1 mm to the +/−0.05 mm tolerances caused by the thickness of the material of the internal overmolding. That means that, in the prior art, the thickness of material in front of the measurement cell may vary by +/−0.25 mm, when the various tolerances are combined.

For example, sensors for monitoring crankshaft position need to have a very high degree of repeatability of the signal with low signal instability, namely with little fluctuation of the signal, in order to detect speed variation and combustion engine misfires. The fluctuation in the signals from a crankshaft position sensor is dependent on the distance, referred to as “airgap”, between the teeth of a target wheel and the measurement cell. The greater this airgap, the more unstable the sensor signal through fluctuation. According to the prior art, the fluctuation performance of the signal for a Hall-effect sensor is limited by a minimum gap that it is possible to achieve between the measurement cell and the reading face. It then follows that an overmolded sensor according to the prior art cannot conform to the tightest of fluctuation specifications.

In one known sensor solution, the integrated circuit comprises connection leads extending in the plane of the integrated circuit. During the manufacture of the sensor, the integrated circuit is first of all overmolded with a thermoplastic material, for example of PPS (polyphenylene sulfide) type, then the leads are bent and terminals are fixed to said leads so that the integrated circuit can be connected later to a computer of the vehicle once the sensor has been mounted in said vehicle. Once the terminals have been attached to the leads, the magnet is placed in line with the integrated circuit on a V-shaped support that is formed during the overmolding of the integrated circuit, and then the assembly is overmolded using the same thermoplastic material so that only the ends of the terminals protrude, so as to form the sensor. Such a sensor may, however, present problems with sealing and electrical-connection problems caused by the use of the terminals. Furthermore, the integrated circuit may shift slightly while it is being overmolded. In addition, the magnet is placed on the V-shaped support with a degree of clearance so as not to stress the magnet. As a result, the magnet may shift slightly while it is being overmolded, for example by 0.05 to 2 mm, leading to poor positioning of the magnet, thus rendering the sensor measurements imprecise.

In order to at least partially overcome this last disadvantage, it is known practice to use a conical retaining pin to hold the magnet on the V-shaped support and thus limit its shifting during the overmolding. However, it is found that, in the majority of instances, the pin becomes twisted during the injection of overmolding material, and that the magnet nevertheless finds itself in an incorrect position. Furthermore, the problem of the shifting of the integrated circuit while it is being overmolded still arises with this type of solution. In addition, the use of a support and of a pin cannot completely eliminate the shifting of the magnet while it is being overmolded, and cannot solve the problems with the electrical connection and sealing of the sensor.

In order to at least partially overcome these disadvantages, another sensor solution consists in using a metal connection grating defining electrical tracks, known to those skilled in the art as a “leadframe”.

A known method for manufacturing such a sensor comprises the following steps. First of all, the integrated circuit is positioned on a flat first zone of a portion of the leadframe, then the integrated circuit is electrically connected to the leadframe. The integrated circuit is then overmolded using a polyepoxide material, forming lugs and a retaining pin for the magnet, then the leadframe is bent twice so that it can be held on a bonding support. Once the leadframe has been placed on the support, the magnet is accurately positioned using a camera and bonded between the lugs and the pin of the overmolding of the integrated circuit, and then the active assembly is bent a third time in order to position it in its final position for use. The active assembly is then overmolded using a polyepoxide or thermoplastic material to form the sensor. In order to ensure secure adhesion of the external overmolding to the overmolding of the integrated circuit, it is known practice to employ reflow fins. However, in the case of an external overmolding made of polyepoxide, the reflow fins need to have a pointed shape, which is something that is difficult to achieve and therefore expensive, and furthermore leads to poor sealing. Furthermore, such reflow is complicated, for example requiring laser machining, or else impossible to achieve between polyepoxide and thermoplastic if the external overmolding uses a thermoplastic material. The sealing of such a sensor is therefore not satisfactory. In addition, the application of three bending operations to the leadframe leads to the increase in the tolerances on the positioning of the magnet with respect to the integrated circuit. Moreover, the integrated circuit may still shift while it is being overmolded with the polyepoxide material, thus still leading to poor-quality measurements by the sensor. Finally, during the external overmolding, it is very often found that the material does not fully penetrate the internal space of the hollow cylindrical magnet, and this too may have an influence on the quality of the measurements from the sensor and therefore constitutes a significant disadvantage.

In addition, in certain types of sensor, it is known practice to add an assembly of passive components, for example including resistors and capacitors, in order to improve the electromagnetic compatibility of the sensor. In this case, this passive assembly is also overmolded, independently of the active assembly, and then, prior to the step of final overmolding with thermoplastic, the leadframe of the active assembly is then bent over onto the passive assembly in order to bring these closer together so as to improve the role of components of the passive assembly on the integrated circuit. However, such bending may lead to defective positioning of the passive assembly with respect to the active assembly, and this may lead to problems with electromagnetic interference from the sensor on the other elements of the vehicle. In addition, vents may form during the overmolding of the magnetic element.

There is a need for a simple, reliable and effective solution for manufacturing a sensor, notably allowing good repeatability.

### SUMMARY OF THE INVENTION

To this end, an aspect of the present invention relates to a method for manufacturing a sensor for an automotive vehicle, said sensor comprising an integrated circuit and a magnetic element, said method comprising the steps of:

arranging the integrated circuit in a housing of a support zone of a leadframe formed in a metal base plate; said leadframe comprising branches constituting electrical tracks,

electrically connecting the integrated circuit to said branches,

placing the magnetic element against the support zone in line with the integrated circuit and at a predetermined fixed distance from said integrated circuit so as to form a space between the magnetic element and the integrated circuit,

overmolding the assembly formed by the support zone, the integrated circuit and the magnetic element with a polyepoxide material so as to obtain an internal overmolding,

overmolding the internal overmolding with a thermoplastic material so as to obtain the sensor.

The method according to an aspect of the invention allows the integrated circuit, the magnetic element and the leadframe to be positioned with respect to one another precisely and repeatably. In particular, the fact that the integrated circuit is placed in a housing formed in the leadframe means that both the placement of the integrated circuit on the leadframe and the position thereof after overmolding can be made precise, given that the integrated circuit does not move laterally during the overmolding. In addition, the distance between the integrated circuit and the magnetic element allows the overmolding material to correctly encapsulate the magnetic element while at the same time guaranteeing correct positioning thereof and avoiding the formation of vents, particularly in the hollow, if there is one, of the magnetic element. As the receiving surface for receiving the magnetic element on the support zone is preferably planar, this allows stable positioning of the magnetic element which remains stable while it is being overmolded. Furthermore, the use of a base plate allows the leadframe to be kept stable while the assembly formed by the support zone, the integrated circuit and the magnetic element is being overmolded. The method thus notably makes it possible to leave the smallest possible gap between a reading face of the sensor and the active assembly.

Advantageously, the integrated circuit and/or the magnetic element may be bonded to the support zone of the leadframe so that they are fixed while they are being overmolded.

As a preference, the method comprises, prior to the step of overmolding with polyepoxide material, a step of placing an assembly of passive electronic components, referred to as “passive” assembly, comprising at least one passive electronic component, for example a resistor or a capacitor, on a zone referred to as “passive” zone of the leadframe, which zone is different than the support zone, the step of overmolding with polyepoxide material further comprising the overmolding of said passive assembly so as to form a passive entity, distinct from the internal overmolding, and which are connected to said internal overmolding by the branches of the leadframe.

As a preference, the method comprises, during the step of overmolding with polyepoxide material, the overmolding of a middle zone of the leadframe, neighboring the support zone, so as to form a positioning member, preferably of complementary shape, designed to receive the internal overmolding.

As a preference, the method comprises, between the step of overmolding with polyepoxide material and the step of overmolding with thermoplastic material, at least one step of bending of the leadframe.

As a preference, the bending comprises the folding the internal overmolding over against the positioning member.

As a preference, with the leadframe comprising two lateral branches and the internal overmolding comprising two lateral slots which are each designed to receive and hold one of said lateral branches, the method comprises, during the folding of the internal overmolding over against the positioning member, a step of clipping (or fixing or insetting) the lateral branches into the slots.

As a preference, when the sensor comprises a passive entity, the overmolding of said passive entity comprises a portion of which the shape complements a portion of the internal overmolding, and the bending comprises the folding of the internal overmolding over onto the passive entity.

As a preference, the method comprises, between the step of overmolding with polyepoxide material and the step of overmolding with thermoplastic material, a step of cutting of the leadframe in order to release it from the base plate.

As a preference, the method further comprises the creation of a rib on the internal overmolding during the overmolding with polyepoxide material, such a rib being able to hold the internal overmolding in position while it is being externally overmolded with the thermoplastic material.

As a preference, the method further comprises the creation of a stud on the internal overmolding during the overmolding with polyepoxide material. Such a stud holds the internal overmolding in a stable position while it is being externally overmolded with the thermoplastic material.

An aspect of the invention also relates to a sensor for an automotive vehicle, said sensor comprising an electronic module and an external overmolding, produced using a thermoplastic material and encapsulating said electronic module, said electronic module comprising:

a metal leadframe comprising a plurality of conducting branches and a support zone comprising a housing,

an internal overmolding, produced using a polyepoxide material and comprising an integrated circuit, placed in said housing, and a magnetic element placed against said support zone and in line with the integrated circuit at a predetermined fixed distance from said integrated circuit so as to form a space between the magnetic element and the integrated circuit.

As a preference, the sensor comprises a plurality of electrical connections between the integrated circuit and the branches of the leadframe, preferably using connecting wires.

As a preference, the internal overmolding comprises a rib on one of its faces.

As a preference, the internal overmolding comprises a pin, preferably on an opposite face to the face comprising said rib.

As a preference, the magnetic element takes the form of a hollow cylindrical magnet of circular cross section.

As a preference, the sensor is a sensor that measures magnetic-field variations brought about by a rotating target such as, in particular, position and speed sensors.

An aspect of the invention finally relates to an automotive vehicle comprising a sensor as disclosed hereinabove, for example mounted in-line with a target of a drive shaft of said vehicle.

### BRIEF DESCRIPTION OF THE DRAWINGS

Further features and advantages of aspects of the invention will become more clearly apparent from reading the following description. This description is purely illustrative and must be read with reference to the accompanying drawings, in which:

FIG. 1 is a perspective view of one embodiment of a sensor according to an aspect of the invention,

FIG. 2 is a perspective view of the electronic module of the sensor of FIG. 1,

FIG. 3 is a perspective view of the leadframe of the sensor of FIG. 1,

FIG. 4 is a side view of the leadframe of FIG. 3,

FIG. 5 is a perspective view of the integrated circuit of the sensor of FIG. 1,

FIG. 6 is a perspective view of the magnet of the sensor of FIG. 1,

FIG. 7 is a partial perspective view of the sensor, from above, illustrating the leadframe of FIG. 3 over which the internal overmolding, the positioning member and the passive entity are overmolded,

FIG. 8 is a perspective view of the sensor of FIG. 7, from beneath,

FIG. 9 illustrates one embodiment of the method of manufacture according to an aspect of the invention,

FIG. 10 is a perspective view of a base plate in which two leadframes are formed,

FIG. 11 is a partial perspective view of the support zone of one of the leadframes of the base plate of FIG. 10, the housing of which receives an integrated circuit,

FIG. 12 illustrates the base plate of FIG. 10 on which two magnetic elements are placed,

FIG. 13 illustrates the base plate of FIG. 12, after the formation of the internal overmolding, of the positioning member and of the passive entity,

FIG. 14 illustrates the base plate of FIG. 13 in which the two internal overmoldings have been folded over onto the positioning member and the passive entity to form two electronic modules.

### DETAILED DESCRIPTION OF THE PREFERRED EMBODIMENTS

The sensor according to an aspect of the invention is intended to be mounted in a vehicle, notably an automotive vehicle, in line with an element capable of causing the magnetic field to vary, for example such as a target of a drive shaft of said vehicle. The sensor may for example be a position sensor for determining the angular position of a shaft, for example a crankshaft or a camshaft, or a speed sensor for determining the rotational speed of a shaft, notably a crankshaft or a camshaft. Since the measurement and application functions of this type of sensor are known per se and do not form the subject-matter of an aspect of the invention, they will not be detailed further here. In particular, it will be noted that an aspect of the invention could be applied to any type of sensor for measuring magnetic-field variations, comprising a measurement cell comprising an integrated circuit and a magnetic element that needs to be positioned in line with said integrated circuit, notably such as a Hall-effect measurement cell.

Sensor 1

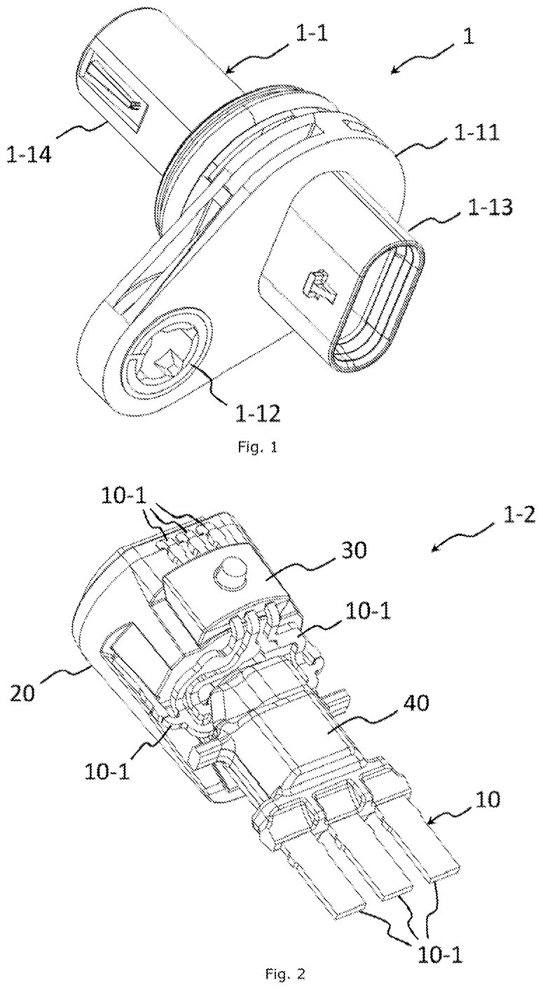

FIG. 1 depicts one embodiment of the sensor 1 according to an aspect of the invention. The sensor 1 comprises an external overmolding 1-1 and an electronic module 1-2 (FIG. 2).

External Overmolding 1-1

The external overmolding 1-1 is a one-piece element made of a thermoplastic material, such as, for example, made of polyphenylene sulfide, or PPS. The external overmolding 1-1 comprises a fixing plate 1-11 for fixing the sensor 1 in the vehicle (not depicted), for example on a rod, via an orifice 1-12. The external overmolding 1-1 also comprises a connection member 1-13 for connection to a connector of the vehicle so as to connect the sensor 1 to a computer of the vehicle, for example via a communication network of CAN bus type, or some other network known to those skilled in the art. The external overmolding 1-1 finally comprises a housing 1-14 in which the electronic module 1-2 is mounted.

Electronic Module 1-2

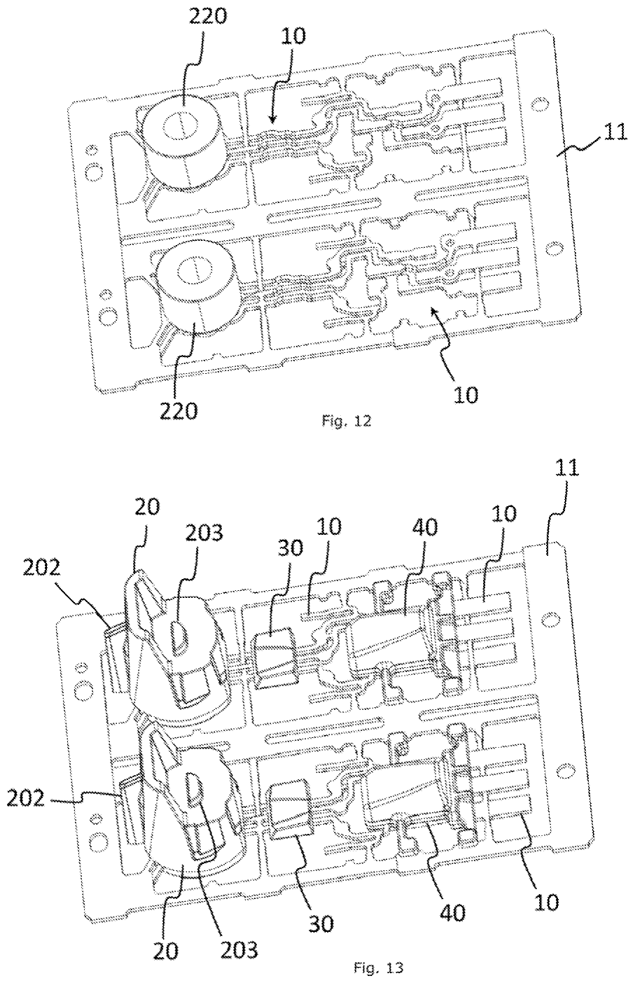

With reference to FIG. 2, the electronic module 1-2 comprises a leadframe 10 and an overmolding which is referred to as “internal” overmolding 20 comprising an integrated circuit 210 (FIGS. 5 and 11) and a magnetic element 220 (FIGS. 6 and 12). Advantageously, the electronic module 1-2 further comprises, in this preferred embodiment, although nonlimitingly, a positioning member 30 and a passive entity 40.

Leadframe 10

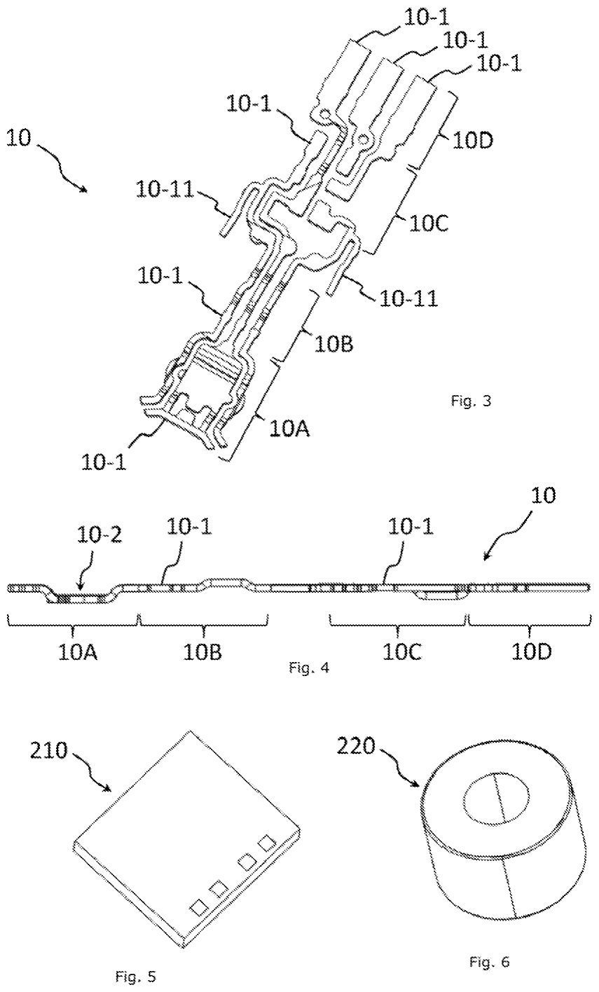

With reference to FIGS. 2 and 3, the connection grating 10, known in the art as a “leadframe” takes the form of an electrically conducting metal component comprising branches 10-1 defining electrical tracks so that the integrated circuit 210 can be electrically connected to a computer of the vehicle via a communication network of said vehicle. In other words, the leadframe 10 is an electrical connection element for connecting the sensor 1 to a connection cable connected to the computer of the vehicle.

With reference to FIGS. 3 and 4, the leadframe 10 comprises several distinct zones: a support zone 10A, a middle zone 10B, a zone referred to as a “passive” zone 10C and a connection zone 10D.

The support zone 10A is intended to receive the internal overmolding 20. The support zone 10A comprises an indentation defining a housing 10-2 designed to receive the integrated circuit 210 so that the magnetic element 220 can be placed against the support zone 10A, at the planar zone peripheral to the housing 10-2 without being in contact with the integrated circuit 210. In other words, the support zone 10A is designed to receive the magnetic element 220 in line with the integrated circuit while maintaining a space between said magnetic element 220 and said integrated circuit 210. This in particular allows the overmolding material to completely fill the hollow internal space of the magnetic element 220, as will be described hereinafter, thus avoiding vents in this zone.

The middle zone 10B is comprised between the support zone 10A and the passive zone 10C and is intended to receive the positioning member 30.

The passive zone 10C is comprised between the middle zone 10B and the passive connection zone 10D and is intended to receive the passive entity 40.

The connection zone 10D in this example comprises three connecting leads constituting free ends of the branches 10-1 so as to electrically connect the electronic module 1-2 to a computer of the vehicle.

In the embodiment described, the leadframe 10 comprises two lateral branches 10-11 (FIG. 3) designed to be received by clip-fastening, namely by fixing or insetting, in two slots 201 (FIG. 6) in the internal overmolding 20 so as to hold said internal overmolding 20 firmly on the leadframe 10.

Internal Overmolding 20

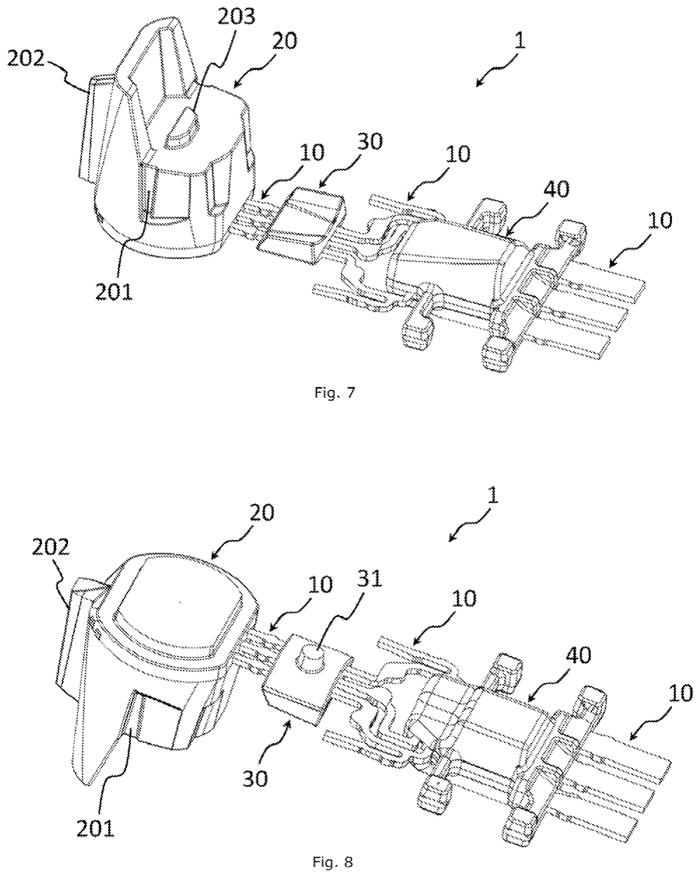

The internal overmolding 20 is produced at the support zone 10A so as to encapsulate said support zone 10A, the integrated circuit placed in the housing 10-2 and the magnetic element 220. With reference to FIG. 7, the internal overmolding 20 is preferably made of a polyepoxide material. The internal overmolding 20 notably comprises two slots 201 positioned one on each side and designed to receive the lateral branches 10-11 of the leadframe 10 when said leadframe 10 is being bent, as will be described hereinafter.

As a preference, still with reference to FIG. 7, the internal overmolding 20 comprises a rib 202 on its rear face and a lug 203 on its top face so as to hold the internal overmolding 20 fixedly in the mold during the external overmolding with the thermoplastic material, as will be described hereinafter.

Integrated Circuit 210

The integrated circuit 210 and the magnetic element 220 constitute the measurement cell of the sensor 1. As a preference, this measurement cell is a Hall-effect measurement cell, particularly in the case of a position or speed sensor 1.

The integrated circuit 210 takes the form of a flat plate of rectangular shape, overmolded with a polyepoxide material. This overmolding of the integrated circuit 210 is performed for example by the manufacturer of said integrated circuit 210, which may be different than the manufacturer of the sensor 1.

The integrated circuit 210 is electrically connected to the branches 10-1 of the leadframe 10, via connecting wires (not depicted), so as to allow the integrated circuit 210 to send to the computer the values of the measurements taken by said integrated circuit 210.

Magnetic Element 220

With reference to FIG. 6, the magnetic element 220 takes the form of a hollow cylindrical magnet of circular cross section. As indicated previously, the magnetic element 220 is designed to be placed against the support zone 10A in line with the integrated circuit 210 at a predetermined fixed distance from said integrated circuit 210 so as to form a space between the magnetic element 220 and the integrated circuit 210.

Positioning Member 30

The positioning member 30 is configured to conform to the internal overmolding 20 so as to hold same in a precise and fixed position during the steps of bending of the leadframe 10, as will be described hereinafter. The positioning member 30 is preferably obtained by overmolding the middle zone 10B with polyepoxide or with thermoplastic material.

The positioning member 30 comprises a receiving face (visible in FIG. 7) for receiving the internal overmolding 20 following the bending of the leadframe 10, as will be explained hereinafter. As a preference, the surface of the internal overmolding 20 and the surface of the passive entity 40 (receiving face) which come into contact with one another during the bending complement one another so as to immobilize the internal overmolding 20 on the positioning member 30 with a view to the overmolding of the whole, as will be described hereinafter. This advantageously makes it possible to reduce the clearances and tolerances associated with the bending and thus to improve the quality of the measurements taken by the sensor 1.

As a preference, with reference to FIG. 8, the positioning member 30 comprises, on the face opposite the receiving face for receiving the internal overmolding 20, a pin 31 so as to hold the passive entity 40 fixedly in the mold during the external overmolding with the thermoplastic material, as will be described hereinafter.

Passive Entity 40

The passive entity 40 is obtained by overmolding, preferably with polyepoxide, at least one passive component placed on the passive zone 10C of the leadframe 10. This or these passive component(s) may for example be one or more resistors and/or one or more capacitors so as to limit the electromagnetic interference generated by the integrated circuit 210 and the magnetic element 220 when the sensor 1 is in operation.

Method of Manufacture

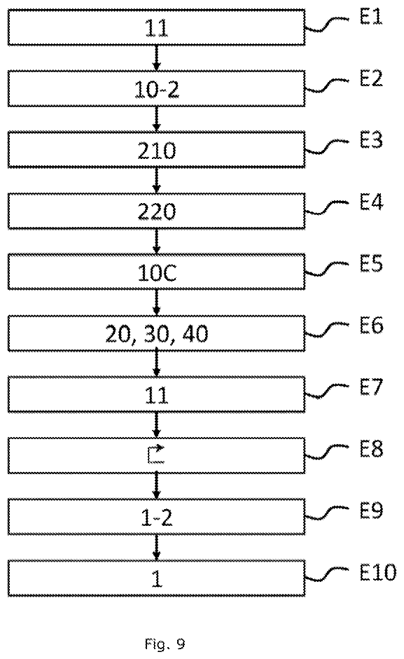

One embodiment of the method for manufacturing the sensor 1 according to an aspect of the invention will now be described with reference notably to FIG. 9 et seq.

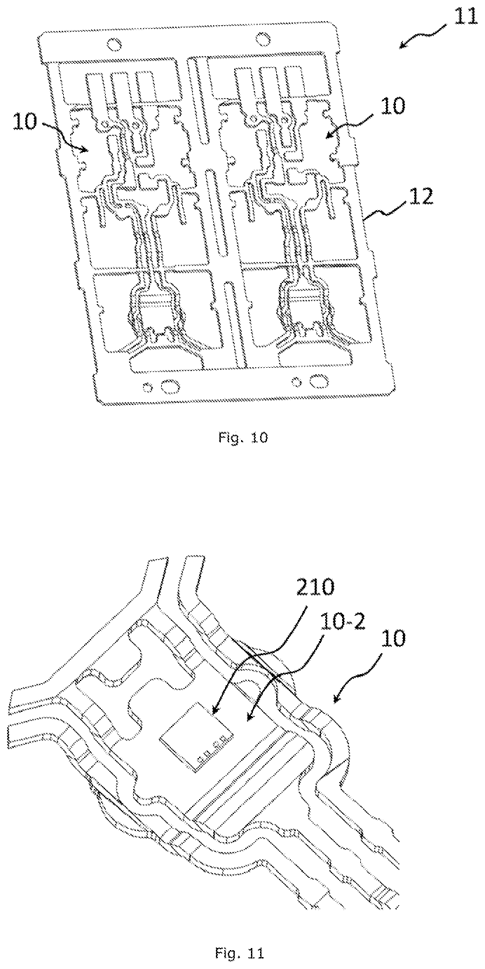

First of all, in a step E1, with reference to FIG. 10, a perforated base plate 11 is manufactured from a conducting metal plate, for example made of copper, so as to form two leadframes 10 comprising the branches 10-1 for creating two sensors 1 according to an aspect of the invention.

These leadframes 10 are connected to a surround 12 that allows the base plate 11 to be held in place during the manufacture of the sensor 1, as will be described hereinafter. It goes without saying that the base plate 11 could also comprise more than two leadframes 10 so as to manufacture more than two sensors 1, or else a single leadframe 10 so as to manufacture just one sensor 1. In what follows, the manufacturing method will be described for the manufacture of a sensor 1 from a leadframe 10 formed in the base plate 11 illustrated in FIG. 10.

In a step E2, with reference to FIG. 11, the integrated circuit 210 is then placed in the housing 10-2 of the support zone 10A and said integrated circuit 210 is electrically connected to the branches 10-1 of the leadframe 10 using electrical connection wires in a step E3.

As illustrated in FIG. 12, the magnetic element 220 is next placed, preferably by bonding it using an adhesive material (of liquid adhesive or any other suitable material type) against the support zone 10A of the leadframe 10 in line with the integrated circuit 210 at a predetermined fixed distance from said integrated circuit in a step E4 so as to form a space between the magnetic element 220 and the integrated circuit 210.

In a step E5, a set of passive electronic components, referred to as a “passive” assembly, comprising at least one passive electronic component, for example a resistor or a capacitor, is next placed on the passive zone 10C of each leadframe 10.

An overmolding step E6, preferably using a polyepoxide material, follows next, preferably in a single step, so as to form three distinct overmolded assemblies connected by the branches 10-1 of the leadframe 10 (FIG. 13):

the internal overmolding 20 comprising the support zone 10A, the integrated circuit 210 and the magnetic element 220 of each sensor 1 being manufactured,

the middle zone 10B, so as to form the positioning member 30 of each leadframe 10, and

the passive assembly, so as to form the passive entity 40 of each leadframe 10.

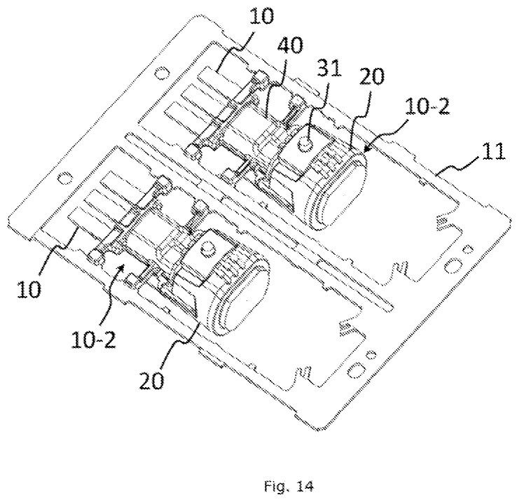

In a step E7, those portions of the base plate 11 that secure the surround 12 to the support zone 10A and to the middle zone 10B are cut and then, in a step E8, each leadframe 10 is bent by folding the internal overmolding 20 over against the positioning member 30, these features having complementary shapes so as to press them firmly against one another. At the end of the bending, the slots 201 of the internal overmolding 20 become fixed to the lateral branches 10-11 of each leadframe 10, and the internal overmolding 20 comes to bear against the passive entity 40 (FIG. 14).

Those portions of the base plate 11 which secure the surround 12 to the passive zone 10C and to the connecting zone 10D are then cut in a step E9, so as to obtain the electronic module 1-2.

Finally, in a step E10, the electronic module 1-2 is overmolded with a thermoplastic material in order to obtain the sensor 1.

1. A method for manufacturing a sensor for an automotive vehicle, said sensor comprising an integrated circuit and a magnetic element, said method comprising:
arranging the integrated circuit in a housing of a support zone of a leadframe formed in a metal base plate; said leadframe comprising branches constituting electrical tracks;
electrically connecting the integrated circuit to said branches;
placing the magnetic element against the support zone in line with the integrated circuit and at a predetermined fixed distance from said integrated circuit so as to form a space between the magnetic element and the integrated circuit;
overmolding the assembly formed by the support zone, the integrated circuit and the magnetic element with a polyepoxide material so as to obtain an internal overmolding; and
overmolding the internal overmolding with a thermoplastic material so as to obtain the sensor.

2. The method as claimed in claim 1, comprising, prior to the step of overmolding with polyepoxide material, a step of placing an assembly of passive electronic components, referred to as “passive” assembly, comprising at least one passive electronic component, on a zone referred to as “passive” zone of the leadframe, which zone is different than the support zone, the step of overmolding with polyepoxide material further comprising the overmolding of said passive assembly so as to form a passive entity, distinct from the internal overmolding, and which are connected to said internal overmolding by the branches of the leadframe.

3. The method as claimed in claim 1, comprising, during the step of overmolding with polyepoxide material, the overmolding of a middle zone of the leadframe, neighboring the support zone, so as to form a positioning member designed to receive the internal overmolding.

4. The method as claimed in claim 2, comprising, between the step of overmolding with polyepoxide material and the step of overmolding with thermoplastic material, at least one step of bending of the leadframe.

5. The method as claimed in claim 4, wherein the bending comprises folding the internal overmolding over against the positioning member.

6. The method as claimed in claim 5, the leadframe comprising two lateral branches and the internal overmolding comprising two lateral slots which are each designed to receive and hold one of said lateral branches, the method comprises, during the folding of the internal overmolding over against the positioning member, a step of clipping the lateral branches into the slots.

7. The method as claimed in claim 4, wherein, when the sensor comprises a passive entity, the overmolding of said passive entity comprises a portion of which the shape complements a portion of the internal overmolding, and the bending comprises the folding of the internal overmolding over onto the passive entity.

8. The method as claimed in claim 1, comprising, between the step of overmolding with polyepoxide material and the step of overmolding with thermoplastic material, a step of cutting the leadframe in order to release it from the base plate.

9. A sensor for an automotive vehicle, said sensor comprising an electronic module and an external overmolding, produced using a thermoplastic material and encapsulating said electronic module, said electronic module comprising:
a metal leadframe comprising a plurality of conducting branches and a support zone comprising a housing; and
an internal overmolding, produced using a polyepoxide material and comprising an integrated circuit, placed in said housing, and a magnetic element placed against said support zone and in line with the integrated circuit at a predetermined fixed distance from said integrated circuit so as to form a space between the magnetic element and the integrated circuit.

10. An automotive vehicle comprising a sensor as claimed in claim 9.

11. The method as claimed in claim 5, wherein the bending (E8) comprises folding the internal overmolding over against the positioning member.

12. The method as claimed in claim 1, comprising, between the step of overmolding with polyepoxide material and the step of overmolding with thermoplastic material, at least one step of bending of the leadframe.
